(19) United States
(12) Patent Application Publication
(10) Pub. No.: US 2026/0360633 A1
(43) Pub. Date: Nov. 12, 2026

(54) CONTACTOR DEVICE, HIGH VOLTAGE POWER SUPPLY SYSTEM AND METHOD FOR CONTROLLING A CONTACTOR DEVICE

(71) Applicant: Munich Electrification GmbH, Munich (DE)

(72) Inventors: Stefan Goede, Munich (DE); Javier Larranaga, Munich (DE); Sebastian Kleppe, Munich (DE); Marcos Gonzalez, Munich (DE)

(21) Appl. No.: 19/142,025

(22) PCT Filed: Dec. 1, 2023
(86) PCT No.: PCT/EP2023/083925

§ 371 Date: Jun. 20, 2025

(30) Foreign Application Priority Data
Dec. 23, 2022 (EP) 22216538

(51) Int. Cl. H01H 1/14; H01H 9/54; H01H 89/04

(52) U.S. Cl. CPC H01H 1/14; H01H 9/54; H01H 89/04

(57) ABSTRACT

The present disclosure relates to a contactor device, a high voltage power supply system comprising the contactor device and a corresponding method for controlling the contactor device. The contactor device (200) comprises a contact arrangement, which includes at least one moveable bus bar (106, 108) and at least one fixed bus bar (102, 104), wherein the at least one moveable bus bar (106, 108) has a first contact region and the at least one fixed bus bar (102, 104) has a second contact region, and at least one actuation element (118), which is configured to change a state of the contactor device (200) at least to and from an open state, and to and from a closed state, wherein in the open state the first contact region is electrically isolated from the second contact region, and in the closed state the first contact region is conductively coupled to the second contact region. The contactor device further comprises an assembled circuit (168), which includes a processing circuit, which is configured to determine at least one operational parameter of the contactor device (200), and a control circuit, which is configured to control the operation of the at least one actuation element (118) in accordance with the operational parameter determined by the processing circuit.

The present disclosure relates to a contactor device, a high voltage power supply system comprising the contactor device and a corresponding method for controlling the contactor device.

The use of contactor devices for connecting and disconnecting electronic circuits in a power supply system is known state of the art. With the advanced development of electric vehicles (EV) or hybrid electric vehicles (HEV), high voltage (HV) power supply systems become more and more common in vehicles. As such high voltage systems nowadays are capable of supplying voltages in a typical range between 400 V and 1 kV and may be even capable of supplying higher voltages in future applications, these high voltage power supply systems present a greater shock hazard than traditional powertrains. Accordingly, the prevention of safety hazards and overcurrent protection is of utmost importance for these systems. For example, it is important to ensure the safety of the vehicle's passengers, of roadside assistance or of maintenance workers, in cases of malfunctions of the high voltage power supply system or of an accident of the vehicle, which affects the electronic circuits of the power supply system.

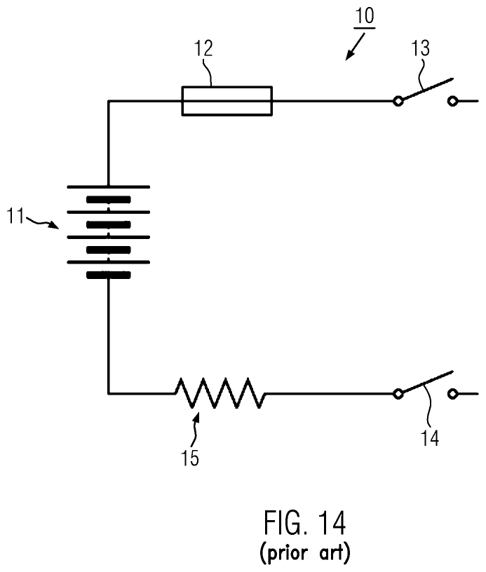

Accordingly, the safety requirements for a power supply system and for contactor devices used to control current flow in the power supply system are increasing, especially where the power supply system is used for storing energy to drive a vehicle. FIG. 14 shows a typical setup of a power supply system 10, which is for example used in an electrified vehicle.

For providing high voltage in the range between 400 V and at least 1 kV to a motor of the EV or HEV vehicle in a driving state, a plurality of batteries modules (or battery packs) are electrically connected to form a high voltage battery 11. Each battery pack usually comprises a plurality of battery cells, which are electrically connected in series and/or in parallel. Hereby, for example, around 80 to 100 battery cells may be electrically connected to form a single high voltage battery pack.

In case that the operation conditions in the power supply system become unsafe, for example due to overcurrent or malfunctions occurring in the electronic circuits of the power supply system or because a vehicle, which is driven by the power stored in the power supply system, has an accident, the current flow in the power supply system should be interruptible immediately and permanently. For this purpose, it is known to connect an additional overcurrent protection device 12 in series to the high voltage battery 11. One example for such an overcurrent protection device 12 is a fuse, which uses a metal wire or a strip that melts, when overcurrent occurs. Recently, also the use of pyroelectric devices, also known as pyrofuses, which are activated by triggering a pyroelectric charge for severing a busbar being mounted in the supply line of the power supply system, has been established as overcurrent protection devices 12. Overcurrent protection devices 12 can be located at the positive terminal of the battery 11, at the negative terminal of the battery 11, within the battery 11 or in several locations of the HV power supply system 10.

In order to connect and disconnect the battery 11 on the positive terminal and on the negative terminal to a DC bus that connects the battery to external loads (or to a charger), a positive main contactor 13 and a negative main contactor 14 are electrically connected in series with the terminals of the battery 11. External loads may include high voltage components, like motor inverters (DCAC converters), DCDC converters, or chargers (ACDC converters), heaters, auxiliary loads or other high voltage components. Conventional contactor devices are capable of reversibly changing a state between a closed state, where current flow through the contactor device is possible and an open state, where current flow through the contactor device is prevented, usually by moving at least one moveable contact.

In order to measure a battery current provided by the battery, the power supply system 10 usually also comprises one or more current sensors, often in form of a dedicated shunt resistor 15, which is electrically connected in series with the HV battery 11. The power supply system 10 contains electronics to measure a voltage drop across the shunt resistor 15. Typically, these electronics are part of a battery management system (BMS, not shown), which monitors the operation of the power supply system 10. The battery management system also often controls the actuation of the positive main contactor 13 and the negative main contactor 14, and controls and diagnoses the functioning of the fuse or pyro fuse 12.

Accordingly, in conventional power supply systems, various individual components need to be interconnected in the HV power supply system, for example, when assembling the HV battery power supply system 10, or a sub-assembly of the HV battery, e.g. a HV battery junction box or a HV battery disconnection unit or a HV battery power distribution unit. For connecting the individual components of the power supply system 10, typically copper or aluminium busbars are used. The interfaces between the individual components are mostly bolted or accomplished by connectors. In rare cases also welding may be applied, when the individual components provide weld interfaces, but bolt interfaces. Accordingly, depending on the type of interconnection, the interfaces between battery 11 and fuse 12, between fuse 12 and positive main contactor 13, between battery 11 and shunt current sensor 15 and the interface between shunt current sensor 15 and negative main contactor 14 all introduce an additional ohmic resistance into a main battery current path. Depending on the interconnection technology, these interfaces may become a large source of energy loss and unintended heat generation. Especially in high power applications, such as fast charging, this issue becomes a system level limitation, which limits the charging currents applicable in the power supply system and can prolong the charging duration. Furthermore, it is necessary that the BMS of the power supply system 10 needs dedicated control and monitoring functions for each of the components comprises in the power supply system 10, so that the structure of the BMS can become complicated.

In this respect, the inventors of the present invention have recognized that there is still a need for a contactor device, which can provide a higher integration of functionalities and/or can lower the interconnections necessary in a power supply system. Accordingly, it is an object of the present invention to provide an improved contactor device for high voltage applications, a high voltage energy storage system comprising the contactor device and a corresponding method for controlling the contactor device, which can provide a higher level of functional integration and/or can lower the necessary interconnections and the associated interconnection resistances in a power supply system. Furthermore, it is an object of the present invention to provide a space- and weight-saving and economic solution.

At least one of these objects is solved by the subject matter of the independent claims. Advantageous aspects of the present disclosure are the subject matter of the dependent claims.

In particular, the present disclosure provides a contactor device, which comprises a contact arrangement, which includes at least one moveable bus bar and at least one fixed bus bar, wherein the at least one moveable bus bar has a first contact region and the at least one fixed bus bar has a second contact region, and at least one actuation element, which is configured to change a state of the contactor device at least to and from an open state, and to and from a closed state, wherein in the open state the first contact region is electrically isolated from the second contact region, and in the closed state the first contact region is conductively coupled to the second contact region. The contactor device further comprises an assembled circuit, which includes a processing circuit, which is configured to determine at least one operational parameter of the contactor device, and a control circuit, which is configured to control the operation of the at least one actuation element in accordance with the operational parameter determined by the processing circuit.

In other words, the present disclosure is based on the idea of integrating the assembled circuit as an internal controller into the contactor device. In this manner, it is possible to transfer control functions for controlling the operation of the contactor device, which are usually performed by an external controller like a battery management system or an electronic control unit (ECU) of a vehicle to the internal controller of the contactor device. This allows to provide the battery management system or the vehicle ECU with a simplified structure and allows a quicker and more cost efficient assembly of the HV power supply system or a battery pack. Depending on the level of functional integration of the assembled circuit, it may become even possible that the internal controller of the contactor device can replace an external battery management system.

According to a second example, the contactor device may comprise a contactor housing, which at least partially houses the first bus bar and the second bus bar, wherein the assembled circuit is encompassed by the contactor housing. In an optional implementation of the second example, the contactor housing is a hermetically sealed housing, which further helps in suppressing the formation of arcs, since the sealed housing may be filled with a vacuum and/or an electronegative gas.

According to a third example, the contactor device further comprises at least one second actuator, which, upon activation, is configured to irreversibly prevent current flow through the contact arrangement and the control circuit is configured to control the operation of the at least one second actuator in accordance with the operational parameter determined by the processing circuit. The integration of the second actuator further allows to integrate the functionalities of an overcurrent protection device into the contactor device. Further, also the control functions for activating and monitoring the functionality of the overcurrent device can be transferred from an external controller to the assembled circuit as an internal controller of the contactor device.

In an optional implementation of the third example, the second actuator is a pyrotechnic actuator, but the second actuator may also be a mechanical actuator. In another optional implementation of the third example, the second actuator is configured to irreversibly displace or irreversibly sever one or more of the at least one moveable bus bars, and/or the second actuator is configured to irreversibly displace or irreversibly sever one or more of the at least one fixed bus bars.

According to a fourth example, the at least one operational parameter includes at least one of a contactor current, which indicates a current flowing through the contact arrangement in the closed state of the contactor device, a contactor voltage, which indicates a voltage dropping between an input terminal of the contact arrangement and an output terminal of the contactor arrangement, a leakage path resistance, which indicates a resistance existing between a grounding terminal of the assembled circuit and at least one of the bus bars of the contact arrangement, and a control command received from an external entity for changing the state of the at least one actuation element. In an optional implementation of the fourth example, the at least one operational parameter may include a control command received from an external entity for activating the second actuator.

In other words, the operational parameter can be a control command received by the internal controller (assembled circuit) of the contactor device from the external controller for changing the state of the contactor device by operating the at least one actuation element or by activating the pyrotechnic actuator. Alternatively, the operational parameter may be a measured value, which is either directly determined by the internal controller (assembled circuit) or is determined by the external controller and communicated to the internal controller (assembled circuit).

According to a fifth example, the at least one operational parameter includes at least the contactor current, the assembled circuit comprises a first detection circuit, which is configured to detect a first detection voltage, which is indicative of the contactor current, the processing circuit is configured to determine the contactor current based on the detected first detection voltage, and the control circuit is configured to control the operation of the at least one actuation element in accordance with the determined contactor current. In an optional implementation of the fifth example, the control circuit may further be configured to activate the second actuator in response to a determination that the contactor current is equal or larger than a predetermined current threshold.

In other words, the internal controller of the contactor device may enable detection and determination of the contactor current and may, through communication with the external controller or by using integrated internal control functions, control the at least one actuator element and/or the activation of the second actuator. In this manner a contactor current detection function can be transferred from the external controller of a power supply system to the internal controller (assembled circuit) the contactor device, so that the structure of the battery management system or the vehicle ECU can be further simplified.

According to a sixth example, the contact arrangement comprises a first current sensing element with a first predetermined resistance, the first current sensing element is integrally formed with one of the bus bars included in the contact arrangement, the first detection circuit is configured to detect the first detection voltage by detecting a voltage, which drops across the first current sensing element, and the processing circuitry is configured to determine the contactor current by using the detected first detection voltage and the resistance value of the current sensing element. In this manner, the need for providing an external shunt resistor in a HV power supply system can be dispensed, so that the number of necessary interconnections in the HV power supply system can be reduced and the energy loss and unintended heat generation in the HV power supply system decreases.

According to a seventh example, the contact arrangement comprises a second current sensing element with a second predetermined resistance, the second current sensing element is integrally formed with one of the bus bars included in the contact arrangement, and the first detection circuit is configured to detect the first detection voltage by detecting a voltage, which drops across the second current sensing element. In an optional implementation of the seventh example, the first current sensing element and the second current sensing element are integrally formed with a same bus bar included in the contact arrangement or the first current sensing element and the second current sensing element are integrally formed with different bus bars included in the contact arrangement.

The integration of a second current sensing element in the contactor device allows a redundant measurement of the contactor current, so that two independent voltage detection signals are provided, which are both proportional to the contactor current. In this manner, a single point fault in one of the detection lines used for detecting the voltage drop across one of the first and the second current sensing elements only affects one of the two detection signals, and the determination of the contactor current can be continued.

According to an eight example, the first current sensing element is formed of a first resistive material having a first specific electrical conductivity and a first temperature coefficient, and the second current sensing element is formed of a second resistive material having a second specific electrical conductivity and a second temperature coefficient. Hereby, the first resistive region and the second resistive region may be formed of the same material or the first resistive region and the second resistive region may be formed of different materials.

According to a ninth example, at least a part of the first current sensing element defines a weak point, which supports the second actuator in severing the respective bus bar, with which the first current sensing element is integrally formed. In an optional implementation of the ninth example, the weak point is formed as a predetermined breaking region, so that the respective bus bar is configured to break in the predetermined breaking region in response to the activation of the second actuator, or the weak point is formed as a hinge flexure, so that the respective bus bar is bendable around the hinge flexure in response to the activation of the second actuator. In this manner, the first current sensing element can integrate two functionalities and can support the breaking or bending of a bus bar after the second actuator is activated. Accordingly, it becomes unnecessary to specifically design a weak point in a bus bar, in which the first current sensing element is integrated.

According to a tenth example the at least one operational parameter includes at least the contactor voltage, the assembled circuit comprises a second detection circuit, which is configured to detect a second detection voltage, which is indicative of the contactor voltage, the processing circuit is configured to determine the contactor voltage based on the detected second detection voltage, and the control circuit is configured to control the operation of the at least one actuation element in accordance with the determined contactor voltage.

In other words, in the tenth example, the internal controller of the contactor device may enable detection and determination of the contactor voltage and may, through communication with the external controller or by using integrated internal control functions, control the at least one actuator element in accordance with the determined contactor voltage. In this manner a contactor voltage detection function can be transferred from an external controller of the power supply system to the internal controller (assembled circuit), so that the structure of the battery management system or the vehicle ECU can be further simplified.

According to an eleventh example, the assembled circuit comprises a precharge circuit, which is configured to be conductively coupled in parallel to the contact arrangement for optionally bypassing the contact arrangement, the precharge circuit includes at least one precharge resistor and at least one precharge switch, which is conductively coupled in series to the precharge resistor, and the control circuit is configured to control opening and closing of the precharge switch. By integrating the precharge circuit into the assembled circuit, the need for connecting an external precharge circuit to the contactor device is dispensed, so that the structure of the HV power supply system can be further simplified.

According to a twelfth example, the control circuit is configured to control opening and closing of the precharge switch in accordance with the determined contactor voltage. In this manner, it is possible to internally control the precharging of the contactor device, so that that hazardous current peaks can be avoided when the contactor device is brought into the closed state.

In an optional implementation of the twelfth example, when the determined actual contactor voltage is larger than a predetermined precharge voltage threshold, the control circuit is configured to close the precharging switch and does not change the state of the contactor device from the open state to the closed state, and/or, when the determined actual contactor voltage is equal or smaller than the predetermined precharge voltage threshold, the control circuit is configured to change the state of the contactor device from the open state to the closed state.

According to a thirteenth example, the at least one operational parameter includes at least the leakage path resistance, the assembled circuit comprises a third detection circuit, which is configured to detect a third detection voltage, which is indicative of the leakage path resistance, the processing circuit is configured to determine the leakage path resistance based on the detected third detection voltage, and the control circuit is configured to control the operation of the at least one actuation element in accordance with the determined leakage path resistance. In an optional implementation of the thirteenth example, the control circuit is also configured to control the at least one actuation element to change the state of the contactor device to the open state in response to a determination that the leakage path resistance is equal or larger than a predetermined resistance threshold, and/or the control circuit is configured to activate the second actuator in response to the determination that the leakage path resistance is equal or larger than the predetermined resistance threshold.

In other words, in the thirteenth example, the internal controller of the contactor device may enable detection and determination of the leakage path resistance and may, through communication with the external controller or by using integrated internal control functions, control the at least one actuator element in accordance with the determined leakage path resistance. In this manner a leakage path resistance detection function can be transferred from an external controller of the power supply system to the internal controller (assembled circuit), so that the structure of the battery management system or the vehicle ECU can be further simplified.

According to a fourteenth example the assembled circuit further comprises a leakage path resistance detection circuit conductively coupled with a first node to the contact assembly and with a second node to the grounding terminal of the assembled circuit. The first leakage path resistance detection circuit comprises a voltage divider, which includes a first series circuit with a first leakage path resistance detection resistor and a second leakage path resistance detection resistor conductively coupled in series to each other, a leakage path resistance detection switch, which is conductively coupled in parallel to the first leakage path resistance detection resistor for optionally bypassing the first leakage path resistance detection resistor, so that, when the first leakage path resistance detection switch is closed, the first leakage path resistance detection resistor is short-circuited and that, when the first leakage path resistance detection switch is opened, the first leakage path resistance detection resistor is not short-circuited, and the third detection circuit, wherein the third detection circuit is configured to detect a first leakage path resistance detection voltage across the second leakage path resistance detection resistor, when the first leakage path resistance detection switch is opened, and to detect a second leakage path resistance detection voltage across the second resistor, when the first leakage path resistance detection switch is closed. The processing circuit is configured to determine the leakage path resistance based on the first leakage path resistance detection voltage and the second leakage path resistance detection voltage and a battery voltage of a battery, to which the contactor device is connected.

The present disclosure also relates to a method performed by an assembled circuit of a contactor device for controlling the contactor device, wherein the contactor device comprises a contact arrangement, which includes at least one moveable bus bar having a first contact region and at least one fixed bus bar having a second contact region. The method comprises the steps of determining at least one operational parameter of the contactor device, and controlling the operation of at least one actuation element in accordance with the determined operational parameter. Hereby, the at least one actuation element is configured to change a state of the contactor device at least to and from an open state, and to and from a closed state, wherein in the open state the first contact region is electrically isolated from the second contact region, and in the closed state the first contact region is conductively coupled to the second contact region.

Throughout this document, the term “terminal” is meant to describe a point at which a conductor from an electric device, an electric circuit or an electric component ends, and where a point is provided for electrically connecting an external electric device, an external electric circuit or an external electric component to this conductor. The term “node” may refer to a point where the terminals of one or more circuit components meet or may refer to the entire wire, which conductively couples the terminals of one or more electric circuit components. Further, the terms “electrically connected” and “conductively coupled” describe the establishing of an electrical connection between at least two electric devices, electric components or electric conductors, which allows the flow of electric current. Hereby the electrical connection should not be restricted to a direct coupling of the terminals of the at least two electric devices, electric components or electric conductors, but other electric devices, electric components or electrical conductors may be coupled in between.

The accompanying drawings are incorporated into the specification and form a part of the specification to illustrate several examples of the present disclosure. These drawings, together with the description serve to explain the principles of the disclosure. The drawings are merely for the purpose of illustrating the preferred and alternative examples of how the disclosure can be made and used, and are not to be construed as limiting the disclosure to only the illustrated and described examples. Furthermore, several aspects of the examples may form—individually or in different combinations—solutions according to the present disclosure. The following described examples thus can be considered either alone or in an arbitrary combination thereof. Further features and advantages will become apparent from the following more particular description of the various examples of the disclosure, as illustrated in the accompanying drawings, in which like references refer to like elements, and wherein:

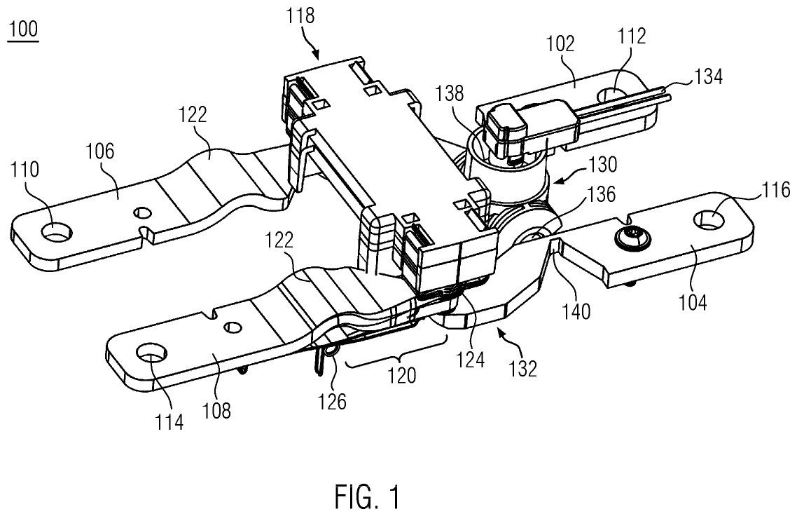

FIG. 1 shows a schematic perspective view of a first exemplary contactor device;

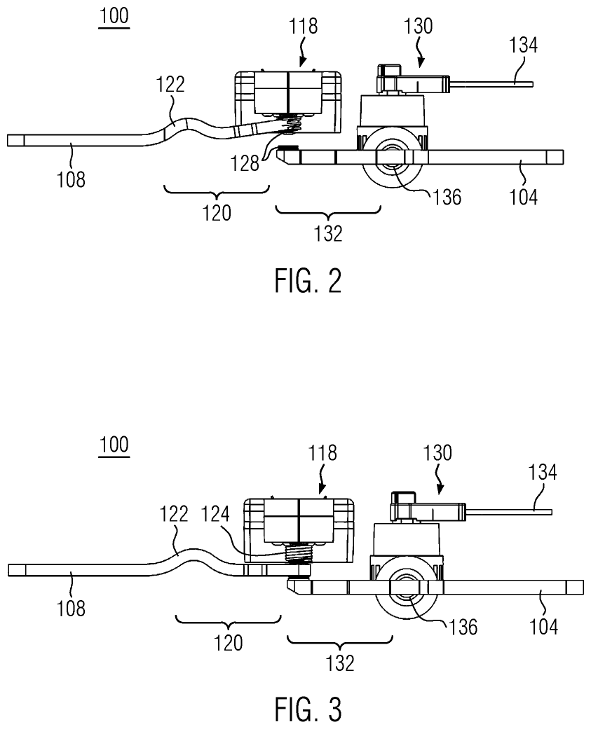

FIG. 2 shows a schematic side view of the first exemplary contactor device in an open state;

FIG. 3 shows a schematic side view of the first exemplary contactor device in a closed state;

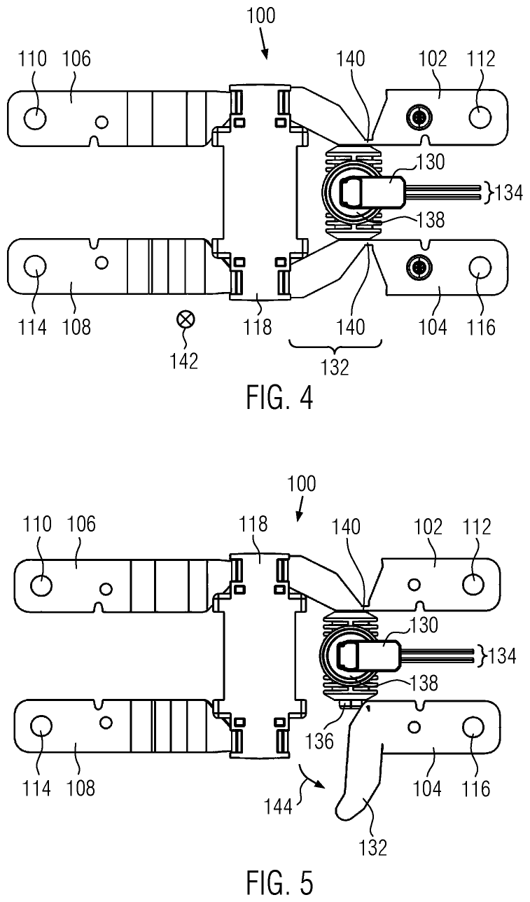

FIG. 4 shows a schematic top view of the first exemplary contactor device;

FIG. 5 shows another schematic top view of the first exemplary contactor device;

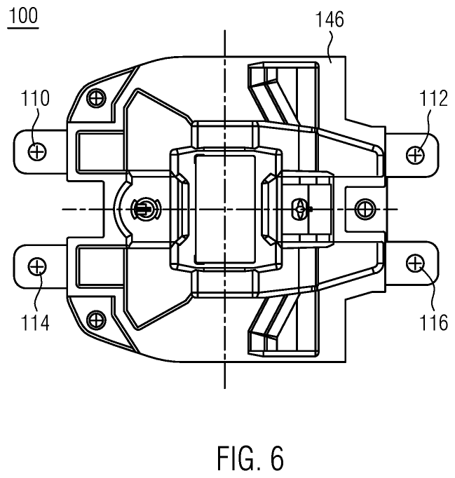

FIG. 6 shows another schematic top view of the first exemplary contactor device;

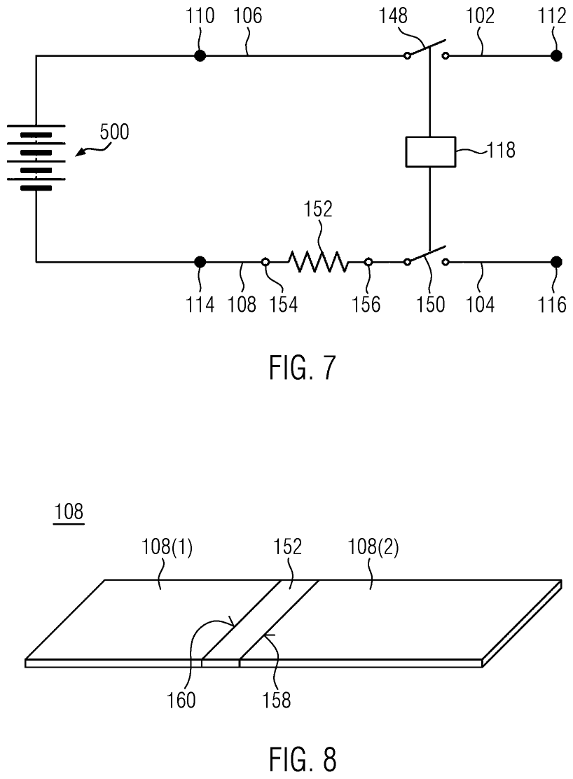

FIG. 7 a schematic circuit diagram of the first exemplary contactor;

FIG. 8 shows a schematic perspective view of a first exemplary bus bar;

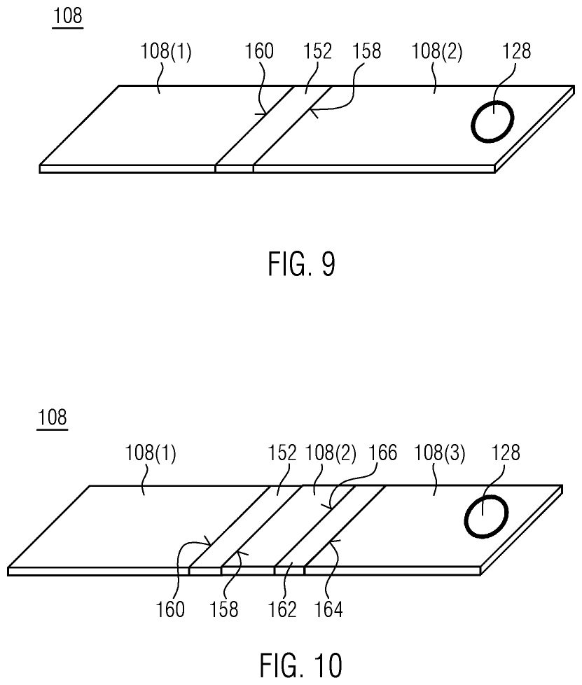

FIG. 9 shows another schematic perspective view of the first exemplary bus bar;

FIG. 10 shows a schematic perspective view of a second exemplary bus bar;

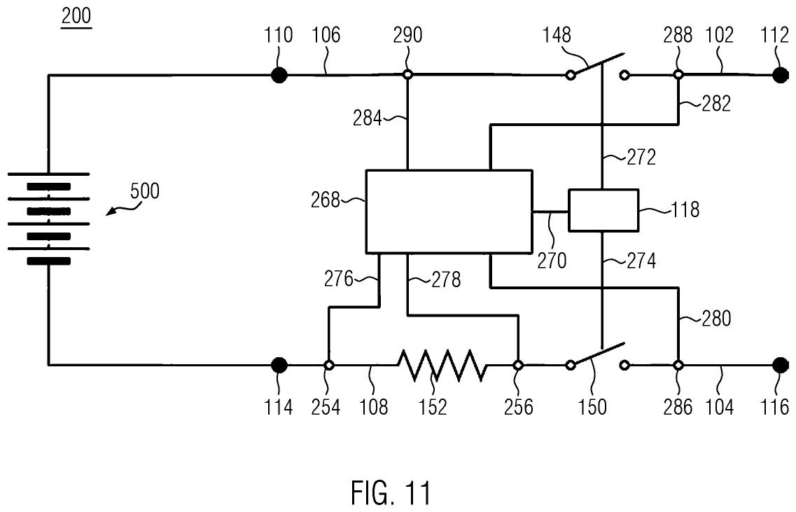

FIG. 11 shows a schematic circuit diagram of a second exemplary contactor device;

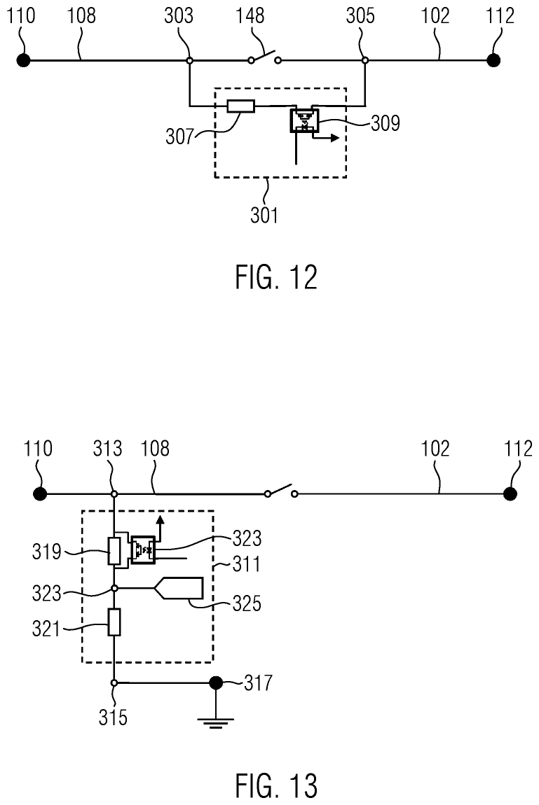

FIG. 12 shows a schematic circuit diagram of an exemplary precharge circuit;

FIG. 13 shows a schematic circuit diagram of an exemplary leakage resistance detection circuit;

FIG. 14 shows a schematic circuit diagram of an exemplary conventional high voltage power supply system.

The present disclosure will now be further explained referring to the Figures, and firstly referring to FIG. 1. FIG. 1 shows a schematic perspective view of a first exemplary contactor device 100. In an application scenario exemplarily described in the following the contactor device 100 may be used in a power supply system of an electric vehicle for controlling the power supply of electric loads like an electric motor, which are supplied at a predetermined high voltage. However, the contactor device 100 may also be used in other application scenarios, which require the storage and/or supply of high voltage energy in one or a plurality of high voltage batteries, like an energy storage system used in an electrical power grid.

The contactor device 100 comprises two fixed bus bars 102 and 104 and two moveable bus bars 106 and 108, which form a contact arrangement of the contactor device 100. In this manner, the contactor device 100 can function as a 2 pole combination contactor, which acts as a 2 pole single-break style contactor.

Advantageously, the design of the contact arrangement of the contactor device 100 allows that respectively one of the fixed bus bars 102 and 104 and respectively one of the moveable bus bars 106 and 108 can function as a first main contactor and the other one of the fixed bus bars 102 and 104 and the other one of the moveable bus bars 106 and 108 can function as a second main contactor, so that the contactor device can integrate the functionalities of two main contactors. However, the number of two moveable bus bars and two fixed bus bars is not essential for the functionality of contactor device 100, but contactor device 100 may have more than two moveable bus bars and more than two fixed bus bars, or may have only one moveable bus bar and one fixed bus bar. Further, it is also conceivable, that the number of moveable bus bars differs from the number of fixed bus bars. For example, the principles of the present disclosure may also be applied to a contactor device, which comprises two fixed bus bars and one moveable bus bars, which is configured to reversibly connect the two fixed bus bars.

Turning back to FIG. 1, it is schematically shown that the moveable bus bars 106 and 108 may be in a closed position, where each of the moveable bus bars 106 and 108 is conductively coupled to one of the fixed bus bars 102 and 104, so that the contactor device is in a closed state. Accordingly, the closed state allows electric current flow between a first terminal 110, which is integrally formed with the moveable bus bar 106, and a second terminal 112, which is integrally formed with the fixed bus bar 102, and between a third terminal 114, which is integrally formed with the moveable bus bar 108, and a fourth terminal 116, which is integrally formed with the fixed bus bar 104. Alternatively, the moveable bus bars 106 and 108 may be in an open position, where each of the moveable bus bars 106 and 108 is electrically isolated from the fixed bus bars 102 and 104, so that the contactor device is in an open state. Accordingly, the open state interrupts the current flow through the contact arrangement of the contactor device 100.

For reversibly connecting and disconnecting the current path through the contactor device 100, the contactor device 100 comprises an electromagnetic actuator 118 as an example of an actuation element. The electromagnetic actuator 118 is configured to reversibly move the moveable bus bars 106 and 108 between the closed position and the open position, in order to change a state of the contactor device 100 to and from the closed state and to and from the open state.

In order to facilitate the reversible transition between the open position and the closed position, the moveable bus bars 106 and 108 are formed in such a way that they are able to deflect elastically between the open and closed position in deflectable bus bar regions 120, which constitute at least a part of the moveable bus bars 106 and 108. For this purpose, the moveable bus bars 106 and 108 may be formed of a multi-layer structure, which comprises, for example, 10 to 15 layers of copper, aluminum or other suitable electrically conducting material. In addition, each of the moveable bus bars 106 and 108 may comprise a bulge 122, for supporting the deflection capability of the moveable bus bars 106 and 108. The bulge 122 may also contribute in applying a preload to the moveable bus bars 106 and 108, which pushes the moveable bus bars 106 and 108 towards the open position.

The electromagnetic actuator 118 is configured to hold the moveable bus bars 106 and 108 in the closed position, when being powered. For this purpose, the deflectable bus bar regions 120 of the moveable bus bars 106 and 108 may be individually moved by the electromagnetic actuator 118, for example by means of a shaft 124, which is arranged on a top side of the moveable bus bars 106 and 108 in the deflectable bus bar region 120. Additional spring elements may be arranged around the shaft 124, which help to absorb small dislocations or imbalances between the moveable bus bars 106 and 108 during operation of the contactor device 100, so as to prevent that such dislocations affect the electromagnetic actuator 118 or greatly impact the force applied between the fixed bus bars 102 and 104 and the moveable bus bars 106 and 108. In this manner, tolerances between the fixed bus bars 102 and 104 and the moveable bus bars 106 and 108 introduced during fabrication of the contactor device 100 can be better compensated. Furthermore, a retaining spring 126 may be situated below each of the moveable bus bars 106 and 108, i.e. on a bottom side of each of the moveable bus bars 106 and 108, so as to bias the moveable bus bars 106 and 108 to be in the open position, when no force is applied by the shafts 124, i.e. when the electromagnetic actuator 118 is not powered.

FIG. 2 shows the contactor device 100 in an unpowered state, where the electromagnetic actuator 118 is not energized, so that the moveable bus bars 106 and 108 are simultaneously in the open position. Accordingly, contact elements 128 of the moveable bus bars 106 and 108 are electrically isolated from contact elements 128 of the fixed bus bars 102 and 104 by a spatial gap, so that current flow through the contact arrangement of the contactor device 100 is interrupted. For reducing a contact resistance, the contact elements 128, may be for example made of silver or any silver alloy, and may be mounted to the fixed bus bars 102 and 104 and the moveable bus bars 106 and 108 by welding, soldering or brazing. Each bus bar may comprise one or more than one contact element, and the contact elements of a bus bar form contact points, which together constitute the contact region of the bus bar for electrically contacting another bus bar of the contact arrangement. Of course, also other suitable electrically conducting materials or interconnection technologies may be used for forming the contact elements 128 on the bus bars of the contactor device 100.

FIG. 3 shows the contactor device 100 in a powered state, where the moveable bus bars 106 and 108 are in the closed position, so that the contact points 128 of the moveable bus bars 106 and 108 are conductively coupled to the contact points 128 of the fixed bus bars 102 and 104.

For bringing the moveable bus bars 106 and 108 from the open position into the closed position, the armature of the electromagnetic actuator 118, applies a closing force to the moveable bus bars 106 and 108, for example through the shafts 124, thereby pushing the moveable bus bars 106 and 108 in a direction of the closing force, i.e. in a direction towards the fixed bus bars 102 and 104.

As an alternative to the electromagnetic actuator 118, the contactor device 100 may be equipped with a linear motor actuator as an actuation element, which moves the moveable bus bars 106 and 108 between the open position (shown in FIG. 2) and the closed position (shown in FIG. 3), by driving the shaft 124 with the linear motor actuator. In such a configuration, the shaft 124 is only moved, when the linear motor actuator is powered, so that the moveable bus bars 106 and 108 remain in the previous position, when the linear motor actuator is not powered. Accordingly, the linear motor actuator can function as a bi-stable actuator, which allows to introduce the open state and the closed state of the contactor device 100 as bi-stable states of the contactor device 100, which are only changed, when the linear motor actuator is powered. Hence with such a configuration, when the linear motor actuator experiences a power loss, for example by a damage event, or due to a communication loss, the contactor device 100 can remain in the closed state (or open state).

Referring back to FIG. 1, the contactor device 100 advantageously may further comprises a pyrotechnic actuator 130, which is configured to permanently displace the fixed bus bars 102 and 104 into a fired position, after the pyrotechnic actuator 130 has been triggered (activated). In the fired position the fixed bus bars 102 and 104 are permanently electrically isolated from the moveable bus bars 106 and 108. Hereby, the fixed bus bars 102 and 104 may be displaced as a whole, or may be displaced only in a displacement region 132 of the fixed bus bars 102 and 104, which includes the contact elements 128. In this manner, it can be prevented that the moveable bus bars 106 and 108 are still capable of conductively coupling to the fixed bus bars 102 and 104 after activation of the pyrotechnic actuator 130. Consequently, current flow through the contact arrangement of the contactor device 100 is interrupted permanently after the activation of the pyrotechnic actuator 130.

The pyrotechnic actuator 130 can comprise two or more pyrotechnic pins 134, which cause ignition of a pyrotechnic charge, in response to the reception of an electric control signal. The pyrotechnic charge may be an explosive, which is directly ignited by the electric control signal or may be a gas generator charge, which suddenly expands after reception of the electric control signal. Alternatively, the pyrotechnic charge may have a multiple charge structure, comprising for example an initiator charge and a secondary gas generator charge.

Alternatively, the pyrotechnic pins 134 may be connected to an internal controller of the contactor device 100, as it will be described later, or may be connected to an external controller, like a battery management system of a high voltage battery or an ECU or a crash sensor of a vehicle. The electric control signal for triggering the pyrotechnic actuator 130 can be, for example, issued by the internal controller or the external controller in response to a detected anomaly or a malfunction in any other circuit component of an electric circuit to which the contactor device 100 is conductively coupled or in response to the detection of an accident of the vehicle.

After activation, the pyrotechnic actuator 130 may drive, propelled by the ignition of the pyrotechnic charge, displacement elements 136 by means of a piston structure 138, in order to push the fixed bus bars 102 and 104 into the fired position, where the fixed bus bars 102 and 104 are electrically isolated from the moveable bus bars 106 and 108. For example, studs or bolts, which are driven by the energy of the piston structure 138 to displace or server the fixed bus bars 102 and 104 may serve as the displacement elements 136.

In order to facilitate the displacement of the fixed bus bars 102 and 104, a weak point (or a weak region) may be formed in each of the fixed bus bars 102 and 104. The weak point may be formed for example in form of a hinge flexure 140. In the shown example, the hinge flexure 140 is formed by a cut-out of the bus bar. A position of the cut-out, which forms the hinge flexure 140 may be adjusted in order to change the swinging radius of the displacement region 132 of the fixed bus bars 102 and 104. In this manner, a movement path of the fixed bus bars 102 and 104 or at least of the displacement region 132 of the fixed bus bars 102 and 104 can be well defined, when the fixed bus bars 102 and 104 are moved into the fired position.

Alternatively, the weak point may be formed by a cut-out or a notch in the respective bus bar, which define a predetermined breaking region. In this manner, the weak point helps in severing or breaking the respective bus bar in the predetermined breaking region in response to the activation of the pyrotechnic actuator 130.

An exemplary operation of the pyrotechnic actuator 130 is shown in FIGS. 4 and 5, which each show a schematic top view of contactor device 100. FIG. 4 shows the contactor device 100 in the closed state before the pyrotechnic actuator 130 is activated. A holding force 142, which points into the paper plane in this example, holds the moveable bus bars 106 and 108 in electrical contact with the fixed bus bars 102 and 104.

FIG. 5 shows a top view of the of the contactor device 100 in a state where the pyrotechnic actuator 130 has been triggered. While only the fixed bus bar 104 is illustrated to be in the fired position, also the fixed bus bar 102 may be moved simultaneously the fired position after triggering the pyrotechnic actuator 130. The pyrotechnically generated force drives the displacement elements 136 to irreversibly move the fixed bus bars 102 and 104 into the fired position, in order to electrically isolate the fixed bus bars 102 and 104 from the moveable bus bars 106 and 108. As indicated by an arrow 144, the fixed bus bars 102 and 104 or the displacement region 132 of the fixed bus bars 102 and 104 performs a rotational movement around the hinge flexure 140, which defines the weak point of the fixed bus bars 102 and 104 in this example. This rotational movement preferably happens in a plane, which is perpendicular to the direction of the holding force 142 applied to the moveable bus bars 106 and 108 by the electromagnetic actuator 118. However, not in all cases the plane, in which the fixed bus bars 102 and 104 or the displacement region 132 of the fixed bus bars 102 and 104 move into the fired position, must be perpendicular to the direction of the holding force 142. Instead, this plane may only enclose a predetermined angle with the direction of the holding force 142, so that the direction of movement of the fixed bus bars 102 and 104 or of the displacement region 132 of the fixed bus bars 102 and 104 at least comprises an angle with respect to the movement direction of the moveable bus bars 106 and 108 between the open position and the closed position.

In this manner, it can be ensured that the fixed bus bars 102 and 104 can be moved into the fired position, without affecting the actuation mechanism for moving and holding the moveable bus bars 106 and 108 in the closed position. Similarly, it is prevented that the motion of the fixed bus bars 102 and 104 into the fired position is affected by the actuation mechanism for moving and holding the moveable bus bars 106 and 108 in the closed position, as the force generated by the pyrotechnic actuator 130 is transmitted in such a way to the fixed bus bars 102 and 104 that it does not work against the forces generated by the electromagnetic actuator 118. Similar the movement of the fixed bus bars 102 and 104 or of the displacement region 132 into the fired position is not restricted to a rotational movement, but may follow a linear movement path.

Notable, the same principles as described above may be applied to the moveable bus bars 106 and 108, so that the pyrotechnic actuator 130 may not permanently displace or sever the fixed bus bars 102 and 104, but the moveable bus bars 106 and 108. Alternatively, a second pyrotechnic actuator may be provided for the contactor device 100, so that respectively one dedicated pyrotechnic actuator permanently displaces or severs the fixed bus bars 102 and 104, and respectively one dedicated pyrotechnic actuator permanently displaces or severs the moveable bus bars 106 and 108. Furthermore, instead of using the energy of one or more pyrotechnic actuator(s) for severing and/or displacing one or more bus bars of the contactor device 100, the energy of one or more mechanical actuators may be used. The mechanical actuator may, for example, be a biased spring, which is configured to permanently sever and/or displace one or more bus bars of the contactor device 100, after the mechanical actuator has been triggered (activated), for example by releasing the biased spring.

In another alternative, instead of mechanically moving one or more bus bar(s) of the contactor device 100 into the fired positon (or breaking the one or more bus bars), the fixed bus bars 102 and 104 may be irreversibly separated from the moveable bus bars 106 and 108, by driving at least one isolation cap, which is formed of electrically insulating material, to completely encompass an end region of the fixed bus bars 102 and 104 after activation of the pyrotechnic actuator 124. In this manner, the isolation cap interrupts the current flow through contact arrangement of the contactor device 100 and at the same time suppress the formation of electric arcs. Details on this activation mode are further explained with respect to FIGS. 23 and 24 of European patent application EP 22177000.1, which is incorporated herein by reference.

FIG. 6 shows the contactor device 100 together with an optional contactor housing 146, which houses a significant part of the internal components of the contactor device 100. In this example, only the terminals 112 and 116 of the fixed bus bars 102 and 104 and the terminals 110 and 114 of the moveable bus bars 106 and 108 are not enclosed by the contactor housing 146. However, the terminals 110, 112, 114 and 116 may be formed by connectors, instead, and the connectors may be integrated into the contactor housing 146. The contactor housing 146 may be a sealed housing, which may be filled with a vacuum or an electronegative gas, in order to suppress the formation of arcs, when opening the moveable contacts 106 and 108. However, by the specific design of the moveable bus bars 106 and 108 already under normal atmosphere sufficient electrical isolation between the moveable bus bars 106 and 108 and the fixed bus bars 102 and 104 can be provided. Accordingly, it is not essential to seal the contactor housing 146 or for to use a vacuum or an electronegative gas. Furthermore, while the terminals 110, 112, 114 and 116 have been shown in FIGS. 1 to 6 as bolt interfaces, it is also possible to use weld interfaces or connectors, which are, for example, provided as part of the connector housing 146 instead.

FIG. 7 shows a schematic circuit diagram of the contactor device 100, conductively coupled to a high voltage battery 500. In the shown example, the first terminal 110 of the contactor device 100 is electrically connected to a positive terminal of the HV battery 500. The second terminal 112 may be electrically connected to the positive voltage side of a high voltage DC bus, which is supplied by the power of the HV battery 500. Similar the third terminal 114 is electrically connected to a negative terminal of the HV battery 500. The second terminal 112 may be electrically connected to the negative voltage side of a HV DC bus. Accordingly, in the shown example, the fixed bus bar 102 and the moveable bus bar 106 function as a positive main contactor (schematically illustrated by reference numeral 148), which can be opened and closed for controlling the electrical connection between the battery 500 and the positive side of the HV DC bus. Similar, the fixed bus bar 104 and the moveable bus bar 108 function as a negative main contactor (schematically illustrated by reference numeral 150), which can be opened and closed for controlling the electrical connection between the battery 500 and the positive side of the HV DC bus.

As described above, and schematically shown in FIG. 7, the two moveable bus bars 106 and 108 are moved by the same actuation element 118, in order to change the state of the contactor device 100 to and from the open state, where the HV DC bus is disconnected from the HV battery 500, and to and from the closed state, where the HV DC bus is connected to the HV battery 500.

FIG. 7 further illustrates a first aspect of the present disclosure, namely the integration of a (first) current sensing element 152, which may be also signified as a shunt resistor or shunt current sensor, into the contactor device 100. The current sensing element 152 is integrally formed with one of the bus bars of the contactor device 100, here for example with the moveable bus bar 108. In this manner, it is not required anymore to connect a separate shunt current sensor in series with the contactor device 100 and the HV battery 500. Accordingly, the integration of the first current sensing element 152 within the contactor device 100 allows to get rid of the (bolted) interconnection between the current sensing element 152 and one of the main contactors 148 and 150 formed by the contact arrangement of the contactor 100.

As a consequence, the moveable bus bar 108 includes the current sensing element 152, which has a predefined resistance and can be used for measuring a battery current provided by the HV battery 500. Since the battery current corresponds to a current flowing through the contactor device, it is throughout this document also signified as “contactor current”. In order to measure a voltage dropping across the first current sensing element 152, the contactor device 100 comprises detection nodes 154 and 156. A battery management system of the battery 500 or another external controller of the HV power supply system, in which the contactor 100 is used, can be electrically connected to the detection nodes 154 and 156, for example by means of a wire harness or a flex circuit. The BMS or external controller can then determine the battery current I_{bat} as

$${I}_{bat} = \frac{{V}_{Res}}{R} , \qquad ( 1 )$$

wherein V_{Res} describes the detected voltage dropping across the first current sensing element 152, and R describes the predefined resistance of the first current sensing element 152. In addition to the voltage drop across the first current sensing element 152, the BMS or the external controller may also determine the temperature of the first current sensing element 152 and may correct the resistance value by considering the temperature coefficient of resistance (TCR). In this manner, it is possible to take into account the temperature-dependency of the resistance of the first current sensing element, so that the battery current can be determined more precisely.

FIGS. 8 to 10 schematically illustrate the integration of the first current sensing element 152 into one of the bus bars of the contact arrangement of the contactor 100. In the following, the moveable bus bar 108, which is arranged on the negative output side of the HV battery 500 in the example of FIG. 7, is shown as an example of one bus bar of the contactor device 100, which is integrally formed with the first current sensing element 152. However, the first current sensing element may instead be integrally formed with the fixed bus bar 104, which is arranged on the negative output side of the HV battery 500 in the example of FIG. 7, or with one of the moveable bus bar 106 or the fixed bus bar 102, which are arranged on the positive output side of the HV battery 500 in the example of FIG. 7. In FIGS. 8 to 10, the dimensions and shape of the exemplary bus bar is shown only schematically, and it should be noted that the inventive concept described with respect to this Figures may in particular be applied to one or more of the moveable bus bars 106 and 108 and the fixed bus bars 102 and 104 of the contactor device 100 as shown and described with reference to FIGS. 1 to 5.

FIG. 8 shows the moveable bus bar 108 in form of an interconnected tri-band, which comprises a first bus bar part 108(1), a second bus bar part 108(2) and the current sensing element 152, which is arranged between the first bus bar part 108(1) and the second bus bar part 108(2). As described above, the first bus bar part 108(1) and the second bus bar part 108(2) may be formed of copper, aluminum or any other suitable electrically conducting material known in the art. In the shown example, the current sensing element 152 is preferably formed as a manganin strip, which is fixedly connected to the first bus bar part 108(1) and the second bus bar part 108(2) at interconnection interfaces 158 and 160 by welding the manganin strip to the first bus bar part 108(1) and to the second bus bar part 108(2).

Other than manganin, it can be also possible to form the current sensing element 152 from Isotan, Isabellin, or constatan, or from another copper alloy containing Copper, Mangan, and/or Nickel. However, also other suitable materials known in the art, which allow to fabricate the current sensing element 152 with a well-defined resistance are conceivable. Instead of welding, the current sensing element 152 may be interconnected to the the first bus bar part 108(1) and to the second bus bar part 108(2) by soldering or brazing or any other suitable interconnection method, which introduces only a small resistance at the interconnection interfaces 158 and 160.

Alternatively, the current sensing element 152 may be directly formed out of the moveable bus bar 108, and accordingly may be formed of a same material as the current sensing element. In this exemplary implementation, the predetermined resistance of the current sensing element 152 may be defined as a region of the first bus bar 108, which is formed with a specific geometry, so that the region forming the current sensing element 152 has a predefined resistance. For example, a constriction, which has a predetermined width and/or thickness in a direction transverse to a main direction of the current flow, may be formed in the moveable bus bar 108 to serve as the current sensing element 152. As a technique for forming the current sensing element 152 from the the moveable bus bar 108, for example stamping or punching may be used. Alternatively, it is also conceivable, that certain parts of precast bus bars are cut out in order to integrate the current sensing element 152 into the bus bar.

By directly forming the current sensing element 152 from a bus bar of the contactor device 100, it is possible to directly fabricate the respective bus bar with the current sensing element in one piece. Accordingly, it is also possible to further reduce the resistance of the interconnection interfaces 158 and 160, since no additional interface resistance needs to be introduced.

FIG. 9 shows an exemplified arrangement of the first current sensing element 152 between the contact element 128 of the moveable bus bar 108 and the third terminal 114 (not shown in FIG. 8), which is integrally formed with the moveable bus bar 108. Here, the second bus bar part 108(2) may for example include the deflectable bus bar region 120, so that the current sensing element 152 is arranged within a static region of the moveable bus bar 108, which is not affected by the actuation of the electromagnetic actuator 118. Accordingly, it is avoided that changing the state of the contactor device has an influence on the detection of the battery current, for example due to a change in the resistance of the current sensing element 152.

In another advantageous configuration, the current sensing element 152 may be arranged in one of the bus bars of the contactor 100 as the weak point, which facilitates the displacement or severing of the respective bus bar. For example, the current sensing element 152 may be arranged as the hinge flexure 140, which was described with respect to FIGS. 1 to 5, in one of the bus bars of the contactor device 100 and allows to displace the respective bus bar. Alternatively, the current sensing element 152 may define a predetermined breaking region, which helps in severing or breaking the respective bus bar in the predetermined breaking region in response to the activation of the pyrotechnic actuator 130 similar as it has been described above especially with respect to FIGS. 4 and 5.

FIG. 10 shows another advantageous configuration of the moveable bus bar 108. In addition to the (first) current sensing element 152, the moveable bus bar 108 may also comprise a (second) current sensing element 162. Like, the first current sensing element 152, the second current sensing element 162 may be formed as a manganin strip, which is fixedly connected to the second bus bar part 108(2) and a third bus bar part 108(3) at interconnection interfaces 164 and 166 by welding the manganin strip to the first bus bar part 108(1) and to the second bus bar part 108(2). However, also the other fabrication techniques and interconnection techniques as described above for integrating the first current sensing element 152 may be used to integrate the second current sensing element 162 into the moveable bus bar 108 or any of the bus bars of the contactor device 100. Hereby, each of the first and the second current sensing elements 152 and 162 may be formed of the same conductive material, or the first and the second current sensing elements 152 and 162 may be formed of different conductive materials.

The integration of a second current sensing element allows a redundant measurement of the battery current, since respectively one voltage drop across each of the first and the second current sensing elements 152 and 162 may be measured, so that two independent voltage detection signals are provided, which are both proportional to the battery current. In this manner, a single point fault in one of the detection lines used for detecting the voltage drop across each of the first and the second current sensing elements 152 and 162 only affects one of the two detection signals, and the determination of the battery current can be continued.

Apparently, the first current sensing element 152 and the second current sensing element 162 may not necessarily be arranged in a same bus bar of the contactor device 100, but may be provided in different bus bars of the contactor device. For example, the first current sensing element 152 may be part of one of the fixed bus bar 104 and the moveable bus bar 108, which are electrically connected with the the negative output side of the HV battery 500 in the example of FIG. 7, and the second current sensing element 162 may be part of one of the fixed bus bar 102 and the moveable bus bar 106, which are electrically connected with the the positive output side of the HV battery 500 in the example of FIG. 7. Furthermore, it is also possible that more than two current sensing elements are integrally formed with the bus bars of the contactor device 100.

FIG. 11 shows a schematic circuit diagram of a second exemplary contactor device 200, being conductively coupled to the high voltage battery 500. Hereby, the elements of the second exemplary contactor device 200, which correspond to elements of the first exemplary contactor device 100, are referenced with corresponding reference numerals. The second exemplary contactor device 200 benefits from a second aspect of the present disclosure, namely the integration of an assembled circuit, which allows to transfer at least a part of the functions of the battery management system of battery 500 to the contactor device 200 or to allow the contactor device 200 to integrate the battery management system of the battery 500, so that the contactor device can function more independently. As will become apparent in the following, the integration of the assembled circuit may be performed without integrating the at least one current sensing element 152 described for the first exemplary contactor device 100 with reference to FIGS. 7 to 11, or may be performed together with the integration of the at least one current sensing element 152.

The assembled circuit 268 comprises a control circuit, which is configured to control the operation of the electromagnetic actuator 118 in order to open and close the positive main contactor 148 formed by the movable bus bar 106 and the fixed bus bar 102, and the negative main contactor 150 formed by the movable bus bar 108 and the fixed bus bar 104 as schematically shown in FIG. 11 by the lines 270, 272 and 274. In this manner, the control circuit of the assembled circuit 268 can directly overtake the control for the actuator 118, so that it becomes unnecessary to implement a control function for the actuator 118 in a battery management system of the HV battery 500 or in another external controller of a HV power supply system, which comprises the HV battery 500.

The control circuit can control the operation of the electromagnetic actuator 118 in accordance with an operational parameter, which is determined by a processing circuit of the assembled circuit. The operational parameter can be a control command received by the processing circuit from an external controller, like a BMS of the battery 500, which is arranged external to the contactor device 200, or a vehicle ECU, for changing the state of the contactor device 100 by operating the electromagnetic actuator 118 or a control command received by the processing circuit from the external entity for activating the pyrotechnic actuator. Alternatively, the operational parameter may be a measured value, which is either directly determined by the processing circuit or is determined by the external controller and communicated to the processing circuit. The measured value can be one of the battery current, a contactor voltage, which indicates a voltage dropping between the first terminal 110 and the second terminal 112 or a voltage dropping between the third terminal 114 and the fourth terminal 116, or a leakage path resistance, which exists between a grounding terminal (or voltage reference terminal) of the assembled circuit and at least one of the bus bars of the contactor device 200.

The assembled circuit 268 may further comprise several peripheral circuits, like a communication circuit, which enables communication between the processing circuit and one or more external controllers, so that the processing circuit can receive and/or transmit control commands to and from the one or more external controllers, which can thus monitor the operation of the contactor device 200. Communication between the communication circuit and the external controller may for example be performed, by using a CAN (Controller Area Network) bus and the CAN protocol, by using an isoSPI (isolated Serial Port Interface) interface and the isoSPI protocol, or by using Ethernet. However, also other known on-board networks and industrial communication protocols may be used.

The peripheral circuits may, for example, also comprise a power supply unit, which supplies power to the circuits of the assembled circuit 268. Hereby, it is possible that the assembled circuit 268 is directly supplied from the HV battery 500. But also another (external) power source for the supply of the assembled circuit 268 is conceivable.

The various circuits of the assembled circuit 268 may be mounted on a single component carrier, to form the assembled circuit as an integrated component. Hereby the term integrated component especially refers to the fact, that all components of the assembled circuit are packaged together as a single compact component. For example, a printed circuit board (PCB) may be used as the component carrier, and by mounting the assembled circuit 268 on the PCB, the PCB becomes an assembled printed circuit board (PCBA).

To further enhance the level of integration, the assembled circuit 268, for example mounted on the PCB to form the PCBA, can be arranged within the contactor housing 146 (shown in FIG. 6). For example, the connector housing may allow to provide a specific housing portion for the assembled circuit 268 and/or may provide specific cooling channels for effectively cooling the assembled circuit 268. The connection interfaces, which are necessary for allowing wired connection between the assembled circuit 268 and the external controller may be provided in the form of connectors, which are integrated into the contactor housing 146. However, it is also conceivable that the communication circuit of the assembled circuit 268 allows wireless communication with the external circuit.

Furthermore, it is possible that the contactor device 200 is not housed in the contactor housing 146. In this case, the PCBA, onto which the assembled circuit 268 is mounted, may be fixed to the contactor device 200, for example by screwing or welding. In such implementation, protection for the PCBA may be for example provided by a protective coating or by overmolding the PCBA.

Besides receiving the measured value from the external controller, the integration level of the contactor device 200 may be further enhanced by implementing additional detection functions in the assembled circuit, in order to allow the assembled circuit to directly detect and/or determine at least one of the battery current, the contactor voltage or the leakage path resistance.

In a first example, the assembled circuit 268 comprises a first detection circuit, which is configured to detect a first detection voltage, which is indicative of the battery current (or contactor current). For this purpose, the contactor device 200 may also include the integrated current sensing element 152, which is integrally formed with one of the bus bars of the contactor 200. Herein, the current sensing element 152 may be designed in any of the ways, which have been described with reference to the first exemplary contactor device 100, and here especially with reference to FIGS. 8 to 10. In order to measure the voltage drop across the current sensing element 152, the first detection circuit may be electrically connected through detection wires 276 and 278 to detection nodes 254 and 256 of the bus bar (in this example the moveable bus bar 108), with which the current sensing element 152 is formed. As described above, more than one current sensing element may be integrally formed with the bus bars of the contactor device 200. In this case, the first detection circuit may be electrically connected to each of the current sensing elements individually through detection wires and may measure a voltage drop across each of the current sensing elements individually.

Notably, it is not essential that an integrated current sensor element is integrally formed with the contactor device 200, but it is also possible to electrically connect the first detection circuit to at least one external shunt resistor (for example shunt resistor 15 shown in FIG. 14) by external wiring. The first detection circuit in this case detects the voltage dropping across the at least one external shunt resistor as the first detection voltage.

On the basis of the detected voltage drop, the processing circuitry is configured to determine the contactor current by using equation (1) described above, wherein the detected first detection voltage is used as the detected dropping voltage V_{Res} and the resistance of the respective current sensing element (or external shunt) as the predefined resistance R. Alternatively, in order to determine the contactor current, the processing circuit may communicate the detected first detection voltage to the external controller and the external controller may calculate the contactor current and communicate the result of the calculation back to the processing circuit.

Based on the result of the determination of the contactor current, the control circuit controls the operation of the electromagnetic actuation element 118 and may optionally also control the activation of the pyrotechnic actuator or an external fuse (for example fuse 12 shown in FIG. 14). For example, due to electromagnetic forces, it may not be possible to separate the moveable contacts 106 and 108 from the fixed contacts 102 and 104, when the contactor current (or battery current) exceeds a predetermined current threshold. Accordingly, if the control circuit determines that the determined contactor current is larger or equal to the predetermined current threshold, the control circuit does not actuate the electromagnetic actuator 118, but issues an activation signal to activate the pyrotechnic actuator or an external fuse instead. However, in some exemplary configurations this activation signal may be issued instead by the external controller, if the external controller determines that the control circuit is unable to interrupt the contactor current through the actuating the electromagnetic actuator 118.

In a second example, the assembled circuit 268 comprises a second detection circuit which is configured to detect a second detection voltage, which is indicative of the contactor voltage. For this purpose, the second detection circuit may determine a voltage dropping across the negative main contactor 150, i.e. a voltage dropping between the moveable bus bar 108 and the fixed bus bar 104. For detecting the voltage drop between the moveable bus bar 108 and the fixed bus bar 104, the second detection circuit may be electrically connected through the detection wire 276 to the detection node 254 of the moveable bus bar 108 and through a detection wire 280 to a detection node 286 of the fixed bus bar 104.

Alternatively, or in addition the second detection circuit may determine a voltage dropping across the positive main contactor 148, i.e. a voltage dropping between the moveable bus bar 106 and the fixed bus bar 102. For detecting the voltage drop between the moveable bus bar 106 and the fixed bus bar 102, the second detection circuit may be electrically connected through a detection wire 282 to a detection node 288 of the fixed bus bar 102 and through a detection wire 284 to a detection node 290 of the moveable bus bar 106.

On the basis of the detected voltage drop(s), the processing circuitry is configured to determine the contactor voltage as the voltage dropping across one of the main contactors 148 and 150 or as an average of these voltages. Again, the determination of the contactor voltage may include that the processing circuit communicates the detected second detection voltage to the external controller and the external controller calculates the contactor voltage and communicate the result of the calculation back to the processing circuit. By implementing the detection of the contactor voltage as a function of the assembled circuit 268, the state of the contactor device 200 can be confirmed by the assembled circuit 268 and/or by an external controller, which monitors the operation of the contactor device 200, so that a determination of the contactor health and wearing can be performed.

Based on the result of the determination of the contactor voltage, the control circuit controls the operation of the electromagnetic actuator 118. For example, due to possible current peaks, which may harm components electrically connected to the HV DC bus, like a DC link capacitor, the control circuit may only actuate the electromagnetic actuator 118 to bring the moveable bus bars 106 and 108 in the closed position, if the determined contactor voltage is equal or smaller than a predetermined voltage threshold, but will refrain from actuating the electromagnetic actuator 118, if the determined contactor voltage is larger than the predetermined voltage threshold.

In order to reduce the contactor voltage before changing the state of the contactor device 100, the assembled circuit may further include a precharge circuit 301, which may be electrically connected in parallel to one of the main contactors 148 and 150. FIG. 12 shows a schematic circuit diagram of an exemplary precharge circuit 301, which is electrically connected in parallel to the positive main contactor 148 by electrically connecting the precharge circuit with a node 303 provided on the moveable bus bar 108 and with a node 305 provided on the fixed bus bar 102 for electrically connecting the precharge circuit to the respective bus bar. The precharge circuit comprises at least one precharge resistor 307 and at least one precharge switch 309, which are conductively coupled in series in between the nodes 303 and 305. In this manner, the precharge circuit 301 allows to optionally bypass the main contactor 148 formed by the contact points of the moveable bus bar 108 and the fixed bus bar 102, in order to short circuit the terminals 110 and 112 of the contactor device when the precharge switch 309 is closed.

The resistance of the precharge resistor 307 may be chosen depending on application scenarios, so as to limit the maximal current flowing through the precharge circuit 301, so that dangerous current peaks can be avoided when the precharge switch 309 is closed. The precharge switch 309 can be a semiconductor switch, for example a metal-oxide-semiconductor field-effect transistor or an insulated-gate bipolar transistor (IGBT), which can easily be integrated into the assembled circuit 268. But also another type of precharge relay may be used.

The opening and closing of the precharge switch 309 may be controlled by the control circuit of the assembled circuit 268 or maybe controlled by the external controller dependent on the contactor voltage. For example, if it is determined that the contactor voltage is larger than the predetermined voltage threshold, the electromagnetic actuator 118 is not actuated, but the precharge switch 309 is closed. As soon as the contactor voltage reaches or decreases below the predetermined voltage threshold, the electromagnetic actuator 118 may be actuated to bring the moveable contacts 106 and 108 in the closed position, so as to allow current flow through the main contactors 148 and 150. In this manner, the contactor device 200 is only brought into the closed state, when the contactor voltage is equal or smaller than the predetermined voltage threshold, so that the risk for generating hazardous current peaks after closing the moveable contacts 106 and 108 can be significantly reduced. Since the precharge circuit 301 is an integral part of the assembled circuit 268, it is directly integrated in the contactor device 200, so that the need for connecting an external precharge circuit to the contactor device 200 is dispensed.

In a third example, the assembled circuit 268 comprises a third detection circuit which is configured to detect a third detection voltage, which is indicative of the leakage path resistance between one of the bus bars of the contactor device 200 and a grounding potential (or reference potential), which may for example correspond to the potential of the chassis of a vehicle. For the purpose of leakage path resistance detection, the third detection circuit may be part of a leakage path resistance detection circuit. A circuit diagram of an exemplary leakage path resistance detection circuit 311 is shown in FIG. 13. The leakage path resistance detection circuit 311 is here for example conductively coupled with a node 313 to the moveable bus bar 108 and with a node 315 to a grounding terminal 317 of the contactor device, which may be electrically connected to a chassis of a vehicle or another reference potential.

The leakage path resistance detection circuit 311 comprises at least a first leakage path resistance detection resistor 319 and a second leakage path resistance detection resistor 321, which are conductively coupled in series with a node 323 between the moveable bus bar 108 and the grounding terminal 317. A leakage path resistance detection switch 323 is conductively coupled in parallel to the first leakage path resistance detection resistor 319, so as to optionally bypass (short circuit) the first leakage path resistance detection resistor 319, when the leakage path resistance detection switch 323 is closed. The leakage path resistance detection switch 323 can be a semiconductor switch, for example a metal-oxide-semiconductor field-effect transistor or an insulated-gate bipolar transistor (IGBT), which can easily be integrated into the assembled circuit 268. But also another type of relay may be used.

The third detection circuit (see reference numeral 325 in FIG. 13) is conductively coupled with the node 323 between the first leakage path resistance detection resistor 319 and the second leakage path resistance detection resistor 321. The third detection circuit is configured to detect a first leakage path resistance detection voltage V_{leak,1} across the second leakage path resistance detection resistor 321, when the leakage path resistance detection switch 323 is open, and to detect a second leakage path resistance detection voltage V_{leak,2} across the second leakage path resistance detection resistor 321, when the leakage path resistance detection switch 323 is closed.

Based on the detected leakage path resistance detection voltages V_{leak,1} and V_{leak,2}, the processing circuitry is configured to determine the leakage path resistance of the contact arrangement of the contactor by using the following equation (2),

$${R}_{iso} = {R}_{S T 1} ( \frac{{V}_{b a t} - {V}_{l eak , 2}}{{V}_{l eak , 2}} - \frac{{V}_{b a t} - {V}_{l eak , 1}}{{V}_{l eak , 1}} ) , \qquad ( 2 )$$

where Vbat is the voltage of the battery 500 and R_{ST1} is the resistance of the leakage path resistance detection circuit 311 when the leakage path resistance detection switch 323 is closed. A more detailed description of the leakage path resistance determination can be found with respect to the description of FIG. 1 of European patent application EP 18 209 536.4, which is incorporated herein by reference. More details of possible leakage path resistance detection circuits 311 can be found in the description of FIGS. 2 and 3 of European patent application EP 18 209 536.4. Of course, the circuits, and methods, which are disclosed in European patent application EP 18 209 536.4 can also be implemented for the leakage path resistance detection of the assembled circuit 268. But also other known leakage path resistance circuits, and detection methods may be implemented for the leakage path resistance detection of the assembled circuit 268.

Instead of electrically connecting the leakage path resistance detection circuit 311 to the moveable bus bar 108, the leakage path resistance detection circuit 311 may be electrically connected to another bus bar of the contactor 200. Furthermore, the leakage path resistance detection may be performed for more than one bus bar of the contactor 200. In particular, it is especially advantageous, if the leakage path resistance detection is performed for one bus bar, which is part of the positive main contactor 148 and for one bus bar, which is part of the negative main contactor 150. Again, the determination of the leakage path resistance may include that the processing circuit communicates the detected third detection voltage to the external controller and the external controller may calculate the leakage path resistance of the contact assembly and communicate the result of the calculation back to the processing circuit.

Based on the result of the determination of the leakage path resistance, the control circuit controls the operation of the electromagnetic actuator 118 or may activate the pyrotechnic actuator 130. In particular, the control circuit may be configured to control the electromagnetic actuator 118 to change the state of the contactor device 200 to the open state, if the control circuit determines that the leakage path resistance of the assembled circuit (i.e. of any bus bar of the assembled circuit) is equal or smaller than a predetermined resistance threshold. If it is not possible to move the moveable contacts anymore, for example because the contactor current is above the predetermined current threshold, the control circuit is configured to activate the pyrotechnic actuator 130 in order to interrupt the current flow through the contactor device permanently. Alternatively, in some exemplary configurations the command for opening the moveable contacts 106 and 108 or the activation signal for activating the pyrotechnic actuator may be issued instead by the external controller and be processed by the processing circuit and the control circuit of the assembled circuit, if the external controller determines that the leakage path resistance of the assembled circuit is equal or smaller than a predetermined resistance threshold.

The detection wires 276, 278, 280, 282 and 284, which electrically connect the individual detection circuits to the respective detection nodes, as well as other wires, which electrically connect components of the assembled circuit, like the precharge circuit 301 and the leakage path resistance detection circuit 311 with one or more of the bus bars of the contactor device 200, may be provided in form of a wire harness or in form of conductors of a flexible PCB. The latter option for example allows to directly integrate the assembled circuit on the flexible PCB in order to further enhance the integration level of the contactor device 200.

Notably, the functionalities of each circuit of the assembled circuit 268 may be realized by software, hardware, or software in cooperation with hardware. Furthermore, each circuit of the assembled circuit 268 can be realized as a dedicated integrated circuit and the dedicated integrated circuits are assembled to form the assembled circuit. Alternatively, the functionalities of each circuit may be integrated into a common integrated circuit, which forms the assembled circuit. Alternatively, one or more circuits of the assembled circuit may be realized by using general-purpose processors, special-purpose processors, or FPGAs (Field Programmable Gate Array) that can be programmed.

Furthermore, the voltage detection circuits of the assembled circuit may be formed by dedicated analog to digital converters (ADC-converters), or may be formed by a single ADC converter, which performs the individual voltage detections as described above in a serial order.

The present disclosure also relates to a high voltage power supply system, which comprises the first exemplary contactor device 100 or the second exemplary contactor device 200 and the battery 500. The HV power supply system may further comprise the external controller, for example a BMS of the battery 500 or the vehicle ECU, which control the operation of the battery 500. As described above, the external controller may control the operation of the contactor device either alone (for the contactor device 100) or in interplay with an internal controller (assembled circuit 268) of the contactor (contactor device 200). Hereby, it is possible that the internal controller can overtake at least a part functionalities of the external controller and accordingly can at least partly control the contactor device independent from the external controller. In particular, the internal controller in form of the assembled circuit 268 may even replace the BMS of the battery 500. Furthermore, the contactor devices 100 and 200 may allow to directly electrically connect the contactor device 100 or 200 to the HV battery 500 without connecting external bus bars in between. This may be achieved, by extending the length of the bus bars of the contact assembly on the side of the battery, for example the moveable bus bars 106 and 108 in the described examples. This reduces the likelihood of a short circuit during assembling of the HV power supply system or in case of a vehicle crash. Further, the contactor devices 100 and 200 can be installed within a battery pack formed by the HV battery 500 by only connecting two conductive element.

As should have been apparent from the above description, the ideas of the first aspect of the present disclosure the ideas of the second aspect of the present disclosure may be combined individually or in combination to enhance the integration level of a contactor device and to help in providing a cheap, space- and weight saving contactor device. But it should be noted that the integration of a current sensing element into a contactor device is not essential for the implementation of the second aspect of the present disclosure, and likewise, the integration of an assembled circuit into a contactor device is not essential for the implementation of the first aspect of the present disclosure.

### REFERENCE NUMERALS

| | |
|---|---|
| 10 | Power supply system |
| 11 | (High voltage) battery |
| 12 | Overcurrent protection device |
| 13, 14 | Main contactor |
| 15 | Shunt resistor |
| 100, 200 | Contactor device |
| 102, 104 | Fixed bus bar |
| 106, 108 | Moveable bus bar |
| 110, 112, 114, 116, | Terminals of the contactor |
| 317 | |
| 118 | Electromagnetic actuator |
| 120 | Flexible contact region |
| 122 | Bulge |
| 124 | Shaft |
| 126 | Retaining spring |
| 128 | Contact elements |
| 130 | Pyrotechnic actuator |
| 132 | Displacement region |
| 134 | Pyrotechnic pins |
| 136 | Displacement elements |
| 138 | Piston structure |
| 140 | Hinge flexure |
| 142 | Holding force |
| 146 | Contactor housing |
| 148, 150 | Main contactors |
| 152 | (First) current sensing element |
| 154, 156, 254, 256, | Detection nodes |
| 286, 288, 290 | |
| 158, 160, 164, 166 | Interconnection interface |
| 168 | Assembled circuit |
| 276, 278, 280, 282, | Detection wires |
| 284 | |
| 301 | Precharge circuit |
| 303, 305, 313, 315, | Nodes |
| 323 | |
| 307 | Precharge resistor |
| 309 | Precharge switch |
| 311 | Leakage path resistance detection circuit |
| 319, 321 | Leakage path resistance detection resistor |
| 325 | Third detection circuit |
| 10 | power supply system |
| 11 | (high voltage) battery |
| 12 | overcurrent protection device |
| 13, 14 | main contactor |
| 15 | shunt resistor |

1. A contactor device comprising:
a contact arrangement, which includes at least one moveable bus bar and at least one fixed bus bar, wherein the at least one moveable bus bar has a first contact region and the at least one fixed bus bar has a second contact region;
at least one actuation element, which is configured to change a state of the contactor device at least to and from an open state, and to and from a closed state, wherein in the open state the first contact region is electrically isolated from the second contact region, and in the closed state the first contact region is conductively coupled to the second contact region; and
an assembled circuit, which includes
a processing circuit, which is configured to determine at least one operational parameter of the contactor device; and
a control circuit, which is configured to control the operation of the at least one actuation element in accordance with the operational parameter determined by the processing circuit.

2. The contactor device according to claim 1, further comprising a contactor housing, which at least partially houses the first bus bar and the second bus bar, and wherein the assembled circuit is encompassed by the contactor housing;
optionally, wherein the contactor housing is a hermetically sealed housing.

3. The contactor device according to claim 1, further comprising at least one second actuator, which, upon activation, is configured to irreversibly prevent current flow through the contact arrangement;
wherein the control circuit is configured to control the operation of the at least one second actuator in accordance with the operational parameter determined by the processing circuit;
optionally, wherein the second actuator is a pyrotechnic actuator;
optionally, wherein the second actuator is a mechanical actuator;
optionally, wherein the second actuator is configured to irreversibly displace or irreversibly sever one or more of the at least one moveable bus bars, and/or
optionally, wherein the second actuator is configured to irreversibly displace or irreversibly sever one or more of the at least one fixed bus bars.

4. The contactor device according to claim 1, wherein the at least one operational parameter includes at least one of:
a contactor current, which indicates a current flowing through the contact arrangement in the closed state of the contactor device;
a contactor voltage, which indicates a voltage dropping between an input terminal of the contact arrangement and an output terminal of the contactor arrangement;
a leakage path resistance, which indicates a resistance existing between a grounding terminal of the assembled circuit and at least one of the bus bars of the contact arrangement;
a control command received from an external entity for changing the state of the at least one actuation element; and
optionally, a control command received from an external entity for activating the second actuator.

5. The contactor device according to claim 4, wherein the at least one operational parameter includes at least the contactor current; and
wherein the assembled circuit comprises a first detection circuit, which is configured to detect a first detection voltage, which is indicative of the contactor current,
wherein the processing circuit is configured to determine the contactor current based on the detected first detection voltage, and
wherein the control circuit is configured to control the operation of the at least one actuation element in accordance with the determined contactor current;
optionally, wherein the control circuit is configured to activate the second actuator in response to a determination that the contactor current is equal or larger than a predetermined current threshold.

6. The contactor device according to claim 5, wherein the contact arrangement comprises a first current sensing element with a first predetermined resistance,
wherein the first current sensing element is integrally formed with one of the bus bars included in the contact arrangement;
wherein the first detection circuit is configured to detect the first detection voltage by detecting a voltage, which drops across the first current sensing element; and
wherein the processing circuitry is configured to determine the contactor current by using the detected first detection voltage and the resistance value of the current sensing element.

7. The contactor device according to claim 6, wherein the contact arrangement comprises a second current sensing element with a second predetermined resistance,
wherein the second current sensing element is integrally formed with one of the bus bars included in the contact arrangement,
wherein the first detection circuit is configured to detect the first detection voltage by detecting a voltage, which drops across the second current sensing element;
optionally, wherein the first current sensing element and the second current sensing element are integrally formed with a same bus bar included in the contact arrangement; or
optionally, wherein the first current sensing element and the second current sensing element are integrally formed with different bus bars included in the contact arrangement.

8. The contactor device according to claim 7, wherein the first current sensing element is formed of a first resistive material having a first specific electrical conductivity and a first temperature coefficient, and the second current sensing element is formed of a second resistive material having a second specific electrical conductivity and a second temperature coefficient;
optionally, wherein the first resistive region and the second resistive region are formed of the same material; or
optionally, wherein the first resistive region and the second resistive region are formed of different materials.

9. The contactor device according to claim 6, wherein at least a part of the first current sensing element defines a weak point, which supports the second actuator in severing the respective bus bar, with which the first current sensing element is integrally formed;
optionally, wherein the weak point is formed as a predetermined breaking region, so that the respective bus bar is configured to break in the predetermined breaking region in response to the activation of the second actuator; and/or
optionally, wherein the weak point is formed as a hinge flexure, so that the respective bus bar is bendable around the hinge flexure in response to the activation of the second actuator.

10. The contactor device according to claim 4, wherein the at least one operational parameter includes at least the contactor voltage;
wherein the assembled circuit comprises a second detection circuit, which is configured to detect a second detection voltage, which is indicative of the contactor voltage,
wherein the processing circuit is configured to determine the contactor voltage based on the detected second detection voltage, and
wherein the control circuit is configured to control the operation of the at least one actuation element in accordance with the determined contactor voltage.

11. The contactor device according to claim 10, wherein the assembled circuit comprises a precharge circuit, which is configured to be conductively coupled in parallel to the contact arrangement for optionally bypassing the contact arrangement,
wherein the precharge circuit includes at least one precharge resistor and at least one precharge switch, which is conductively coupled in series to the precharge resistor, and
wherein the control circuit is configured to control opening and closing of the precharge switch.

12. The contactor device according to claim 11, wherein the control circuit is configured to control opening and closing of the precharge switch in accordance with the determined contactor voltage,
optionally, wherein, when the determined actual contactor voltage is larger than a predetermined precharge voltage threshold, the control circuit is configured to close the precharging switch and does not change the state of the contactor device from the open state to the closed state, and/or
optionally, wherein, when the determined actual contactor voltage is equal to or smaller than the predetermined precharge voltage threshold, the control circuit is configured to change the state of the contactor device from the open state to the closed state.

13. The contactor device according to claim 4, wherein the at least one operational parameter includes at least the leakage path resistance,
wherein the assembled circuit comprises a third detection circuit, which is configured to detect a third detection voltage, which is indicative of the leakage path resistance,
wherein the processing circuit is configured to determine the leakage path resistance based on the detected third detection voltage, and
wherein the control circuit is configured to control the operation of the at least one actuation element in accordance with the determined leakage path resistance;
optionally, wherein the control circuit is configured to control the at least one actuation element to change the state of the contactor device to the open state in response to a determination that the leakage path resistance is equal or larger than a predetermined resistance threshold; and/or
optionally, wherein the control circuit is configured to activate the second actuator in response to the determination that the leakage path resistance is equal or larger than the predetermined resistance threshold.

14. The contactor device according to claim 13, wherein the assembled circuit further comprises a leakage path resistance detection circuit conductively coupled with a first node to the contact assembly and with a second node to the grounding terminal of the assembled circuit, the first leakage path resistance detection circuit comprising:
a voltage divider, which includes a first series circuit with a first leakage path resistance detection resistor and a second leakage path resistance detection resistor conductively coupled in series to each other,
a leakage path resistance detection switch, which is conductively coupled in parallel to the first leakage path resistance detection resistor for optionally bypassing the first leakage path resistance detection resistor, so that, when the first leakage path resistance detection switch is closed, the first leakage path resistance detection resistor is short-circuited and that, when the first leakage path resistance detection switch is opened, the first leakage path resistance detection resistor is not short-circuited, and
the third detection circuit, wherein the third detection circuit is configured to detect a first leakage path resistance detection voltage across the second leakage path resistance detection resistor, when the first leakage path resistance detection switch is opened, and to detect a second leakage path resistance detection voltage across the second resistor, when the first leakage path resistance detection switch is closed, and
wherein the processing circuit configured to determine the leakage path resistance based on the first leakage path resistance detection voltage and the second leakage path resistance detection voltage and a battery voltage of a battery, to which the contactor device is connected.

15. A method performed by an assembled circuit of a contactor device for controlling the contactor device, wherein the contactor device comprises a contact arrangement, which includes at least one moveable bus bar having a first contact region and at least one fixed bus bar having a second contact region, the method comprising:
determining at least one operational parameter of the contactor device, and
controlling the operation of at least one actuation element in accordance with the determined operational parameter;
wherein the at least one actuation element is configured to change a state of the contactor device at least to and from an open state, and to and from a closed state, wherein in the open state the first contact region is electrically isolated from the second contact region, and in the closed state the first contact region is conductively coupled to the second contact region.
